(19) United States
(12) Patent Application Publication
(10) Pub. No.: US 2002/0086265 A1
(43) Pub. Date: Jul. 4, 2002

(54) Device for the destruction of a tooth

(76) Inventors: Horst Langer, Borchen (DE); Iris Bohnenkamp, Bielefeld (DE)

Correspondence Address: LAW OFFICE OF BARRY R LIPSITZ, 755 MAIN STREET, MONROE, CT, 06468, US

(21) Appl. No.: 10/004,351

(22) Filed: Oct. 25, 2001

Related U.S. Application Data
(63) Continuation of application No. PCT/EP00/03531, filed on Apr. 19, 2000.

(30) Foreign Application Priority Data
May 3, 1999 (DE) 299 07 819.1
Aug. 11, 1999 (DE) 299 14 040.7
Aug. 25, 1999 (DE) 299 14 832.7

(51) Int. Cl. A61C 3/08

(52) U.S. Cl. 433/150; 433/141

(57) ABSTRACT

In order to design a device for the destruction of a tooth free from transverse forces and bending moments comprising a destruction bolt which can be introduced into a bore of the tooth such that a destruction of the tooth is possible without transverse forces and bending moments being exerted on the patient it is suggested that the outer dimensions of the destruction bolt be increasable in such a manner that the tooth is broken and thereby split open by means of internal pressure due to application of symmetric forces in the bore.

The present disclosure relates to the subject matter disclosed in International Application No. PCT/EP00/03531 (WO 00/66024) of Apr. 19, 2000, which is incorporated herein by reference in its entirety and for all purposes.

### BACKGROUND OF THE INVENTION

The invention relates to a device for the destruction of a tooth free from transverse forces and bending moments, comprising a destruction bolt which can be introduced into a bore of the tooth.

One complication during the extraction of wisdom teeth can be the impacted position of the tooth, i.e. the wisdom tooth lies more or less horizontally in the jaw socket, the roots pointing towards the mandibular joint. During the extraction of these impacted wisdom teeth a standard method is commonly used: Since the tooth can scarcely be removed as a whole from the jawbone, it is split into several pieces. Once the cavity of the tooth has been opened by cutting open the cover over the tooth, an approximately cylindrical hole is introduced into the tooth of approximately 2 to 3 mm diameter by means of drilling or cutting. Usually, a bolt fitting into the bore and having a length of approximately 15 to 20 cm, at the rear end of which a knob-like handle is seated, is now used and the bolt forcefully bent back and forth in the bore using transversely directed manual forces and utilizing the lever action of the knob-like handle for such a time until the tooth breaks. Additional bores and additional crowbar-like leverage are mostly necessary until the tooth is split into sufficiently small pieces and until all the parts of the tooth can be removed from the tooth socket cavity with forceps or pincers.

The forceful effect on the tooth as described has, of course, a further effect on the jaw and the head of the patient. The consequences of this robust treatment can be manifold:

1. On account of the tooth cavity being cut open the jaw is weakened by the notch effect at this point, and the risk of the jaw being fractured, which is therefore already great as such, is increased even more due to the forces and bending moments introduced.

2. Since the patient cannot absorb the effective bending moments even when he is anesthetized, these bending moments are conducted further and absorbed by the neck and spinal column. The result can be intensive hematomas in the neck and larynx area.

3. If the patient is not anesthetized, he experiences the effect of force and is fully aware of the bone-breaking, grinding noises. This can lead to documented, traumatic conditions following the operation.

It is the object of the invention to design a device of the generic type such that a destruction of the tooth is possible without transverse forces and bending moments of the type described being exerted on the patient so that the disadvantages and consequences which are described and sufficiently known can be avoided.

### SUMMARY OF THE INVENTION

This object is accomplished in accordance with the invention, in a device of the type described at the outset, in that the outer dimensions of the destruction bolt can be increased in such a manner that the tooth is broken and thereby split open by means of internal pressure due to application of symmetric forces in the bore.

In contrast to the known destruction bolt which can be introduced into the bore and merely serves to act upon the tooth with transverse forces and bending moments, the destruction bolt introduced into the bore of the tooth is, therefore, in the case of the device described, increased in its outer dimensions such that it exerts internal forces on the tooth which widen the bore, finally break the tooth and thus split it into parts. In this respect, no bending moments or transverse forces at all are exerted on the patient, the forces acting on the tooth are absorbed solely by the tooth itself which does not, however, experience any external forces which endeavor to displace it in relation to the jaw.

This principle of the application of force by means of internal pressure which is free from transverse forces and thus bending moments is adequately known in technology as such, e.g. during the splitting of blocks of stone by way of water pressure in bores or by way of quick-frozen water or also only for the broadening without destruction during conical press fitting by means of pressure oil.

In a first preferred embodiment it is provided for the destruction bolt to comprise two parts which can be moved relative to one another and have sliding surfaces which slide on one another during the movement of the parts relative to one another and as a result increase the outer dimensions of the destruction bolt.

For example, one part can be a slotted sleeve and the other a central drawing or pressure bolt which can be displaced therein and has a conical extension which forms a sliding surface. If the drawing or pressure bolt is displaced in relation to the slotted sleeve, the conical extension enters the interior of the slotted sleeve and widens this. The sleeve itself can likewise have a conical sliding surface.

In another configuration, one part is designed as a stationary half bolt and the other part as a displaceable drawing or pressure bolt, wherein both parts bear wedge surfaces sliding on one another as sliding surfaces. If the two parts are displaced in axial direction relative to one another, the wedge surfaces slide on one another and press the two parts apart, thereby increasing their outer dimensions.

In a further, preferred embodiment the two parts can be designed like blind rivets. This design makes it possible, in particular, to initiate a uniform pressure via the circumference of the bore.

It is particularly advantageous when the device is a forceps-like tool which is designated in the following as a pair of breaking forceps and when the two parts can be moved relative to one another by means of two forceps handles of the breaking forceps pivotable relative to one another. It is then possible in a very simple manner to move the two parts relative to one another simply by pivoting the forceps handles relative to one another such that the outer dimensions of the parts can be increased for the purpose of breaking the tooth.

In a preferred embodiment, it is thereby provided for the breaking forceps to include a ratchet mechanism, by means of which the complete stroke of the forceps handles is transformed into a small partial stroke of the two parts relative to one another. During the increase in the outer dimensions of the parts due to relative displacement of the two parts in relation to one another, the operating surgeon can proceed very delicately in that he does not bring about the complete displacement of the two parts relative to one another in a single stroke but rather that he makes a plurality of small partial strokes one after the other, wherein the forceps handles are repeatedly moved through their complete stroke. The ratchet mechanism can comprise an elbow lever which engages in teeth with its free end.

It is also advantageous when the two forceps handles can be pivoted into a release position, in which the two parts are displaced relative to one another in such a manner that their outer dimensions are reduced. This is of advantage, in particular, when the widened destruction bolt has to be removed again from the bore, for example, when the tooth has not been successfully split apart. As a result of a corresponding movement of the two parts relative to one another which is triggered by the pivoting of the forceps handles into the release position, the outer dimensions of the two parts are reduced and so the force-locking engagement of the two parts on the inner wall of the bore in the tooth is discontinued.

In a particularly preferred embodiment it is provided for the two parts to be movable away from one another towards opposite sides during the increase in the outer dimensions and for the destruction bolt to be mounted on the device so as to be rotatable about its longitudinal axis. With such a configuration, the breaking forces exerted on the tooth are essentially transferred to the tooth in a plane which is defined by the movement of the two parts. This plane can likewise be turned due to rotation of the destruction bolt about the longitudinal axis and this leads to the operating surgeon being able to adjust the direction of the breaking forces.

In a further, preferred embodiment, it may be provided for the two parts to be movable relative to one another by means of a hydraulic drive for altering the outer dimensions of the destruction bolt.

This hydraulic drive may preferably comprise a pump driven by a motor or a hydraulic piston operated by hand or foot for generating the actuating pressure for the hydraulic drive.

In this respect, it is advantageous when the device has a housing which bears the destruction bolt and accommodates an actuating and supply unit and when the housing forms a forceps-like tool together with a hand lever mounted thereon. This results in a very manageable tool which can be operated like a pair of forceps and displaces the parts of the destruction bolt hydraulically relative to one another.

In a different embodiment, it may be provided for the drive to be connected to an actuating and supply unit via a hose. In this respect, the connection between the hose and the actuating and supply unit may preferably be designed as a plug-in connection.

In a further configuration of a device with parts displaceable hydraulically relative to one another, it may be provided for the hydraulic drive to comprise a piston sealingly displaceable in a bushing, one of the two displaceable parts being held on the piston, i.e. a hydraulic piston-cylinder unit.

In this respect, a particularly simple construction results when a supply line for a hydraulic medium is arranged in the bushing on one side of the piston and when the piston is displaceable in the bushing contrary to the action of a spring during supply of hydraulic medium via this supply line. With such a configuration, the piston is therefore displaced in one direction due to supply of hydraulic medium but in the opposite direction by a spring which is tensioned during the displacement of the piston by the hydraulic medium.

In another configuration, it may, on the other hand, be provided for a supply line for a hydraulic medium to be arranged in the bushing on both respective sides of the piston; the piston is therefore driven by hydraulic medium in a double-acting manner.

A particularly favorable design results when the piston is sealed in relation to the bushing by means of an expansion bellows. It is then possible to use as hydraulic medium not only physiologically harmless liquids, for example, water but also other liquids which should not come into contact with the body, for example, synthetic liquids.

In a further, preferred embodiment, it is provided for the hydraulic drive to comprise a bellows which is arranged between the two parts, can be filled with hydraulic medium and moves the two parts away from one another during filling, thereby increasing their outer dimensions. This bellows is blown up like a balloon during filling with hydraulic medium and therefore pushes the two parts apart. These abut as a result on the inner wall of the bore in the tooth and transfer breaking forces to the inner wall of the bore.

The two parts may, in particular, be mounted so as to be pivotable away from one another.

It is also favorable when the two parts are spring-assisted so that during emptying of the bellows the two parts are brought closer to one another again whilst reducing their outer dimensions.

In a further, preferred configuration of an inventive device, the destruction bolt comprises a bellows which can be filled with a hydraulic medium. This bellows can be introduced directly into the bore of the tooth and abuts on the inner wall of the bore during filling with hydraulic medium; during further filling breaking forces are exerted as a result on the inner wall of the bore of the tooth which finally split it apart.

The bellows can, for example, be of a ball-shaped design or a cylinder-like design.

It is favorable when the bellows bears notched pieces added laterally which come to rest on the inner wall of the bore and assist in the destruction of the tooth.

The bellows is preferably of an expandable design.

The following description of preferred embodiments of the invention serves to explain the invention in greater detail in conjunction with the drawings.

### BRIEF DESCRIPTION OF THE DRAWINGS

FIG. 1 shows breaking forceps in a side view;

FIG. 2 shows a first preferred embodiment of the forceps head of the breaking forceps marked in FIG. 1 with a circle;

FIG. 3 shows a view similar to FIG. 2 in a modified embodiment of a forceps head;

FIG. 4 shows a schematic side view of a breaking unit with a breaking head, a supply and actuating unit and a hose connection between breaking head and supply and actuating unit;

FIG. 5 shows a view similar to FIG. 3 in a modified embodiment of a breaking unit;

FIG. 6 shows a view similar to FIG. 4 in a further, preferred embodiment of a breaking unit;

FIG. 7 shows a sectional view of a first preferred embodiment of a breaking head with a double-acting hydraulic drive;

FIG. 8 shows a view similar to FIG. 7 with a modified design of the destruction bolt;

FIG. 9 shows a view similar to FIG. 7 with an expansion bellows seal;

FIG. 10 shows a view similar to FIG. 8 with an expansion bellows seal;

FIG. 11 shows a view similar to FIG. 7 with a single-acting hydraulic drive and a restoring spring;

FIG. 12 shows a view similar to FIG. 8 with a single-acting hydraulic drive and a restoring spring;

FIG. 13 shows a view similar to FIG. 9 with a single-acting hydraulic drive and a restoring spring;

FIG. 14 shows a view similar to FIG. 10 with a single-acting hydraulic drive and a restoring spring;

FIG. 15 shows a diagrammatic illustration of a supply and actuating unit for a double-acting hydraulic drive with a pump driven by a motor;

FIG. 16 shows a diagrammatic view of a supply and actuating unit for a double-acting hydraulic drive with a pump operated by hand;

FIG. 17 shows a view similar to FIG. 15 for a single-acting, hydraulically acting drive;

FIG. 18 shows a view similar to FIG. 16 for a single-acting, hydraulically acting drive;

FIG. 19 shows a schematic view of a screw connector for the connection of a destruction bolt in the form of a bellows;

FIG. 20 shows a longitudinal sectional view through a first, preferred embodiment of a bellows-like destruction bolt fillable with a hydraulic medium;

FIG. 21 shows a view similar to FIG. 20 in a modified embodiment of a destruction bolt;

FIG. 22 shows a view similar to FIG. 21 with a destruction bolt bearing notched pieces;

FIG. 23 shows a sectional view along line 23-23 in FIG. 22; and

FIG. 24 shows a breaking element in a drilled tooth.

### DETAILED DESCRIPTION OF THE INVENTION

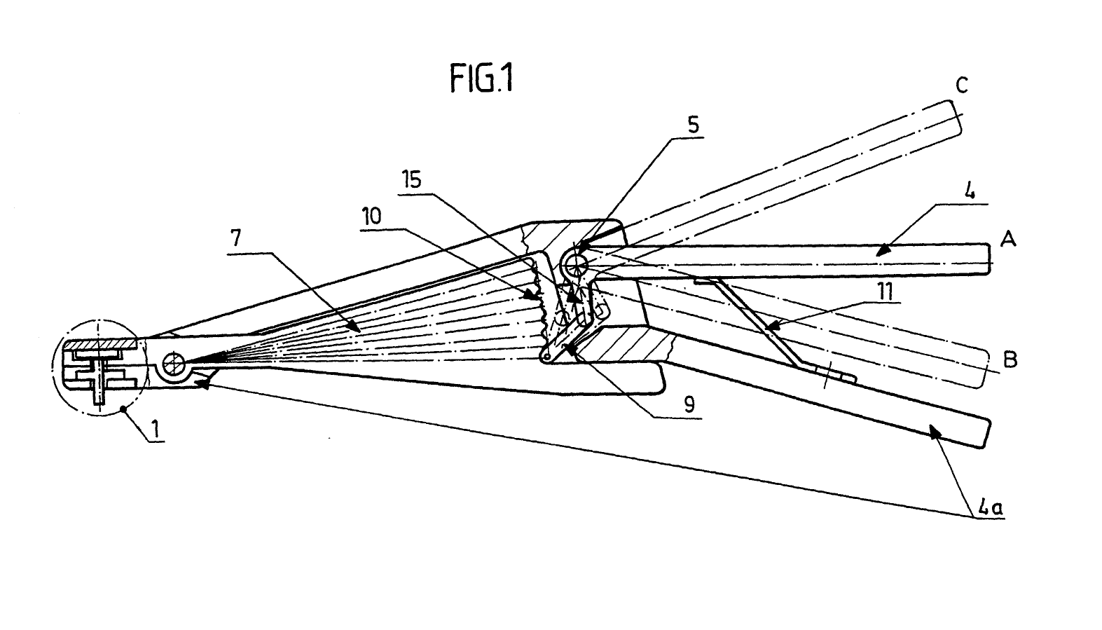

FIG. 1 shows by way of example a whole breaking forceps in the side view with the variation of the forceps head in accordance with FIG. 3. A forceps handle 4 is located

at A in an initial position

at B at the end of a stroke

at C in a release position.

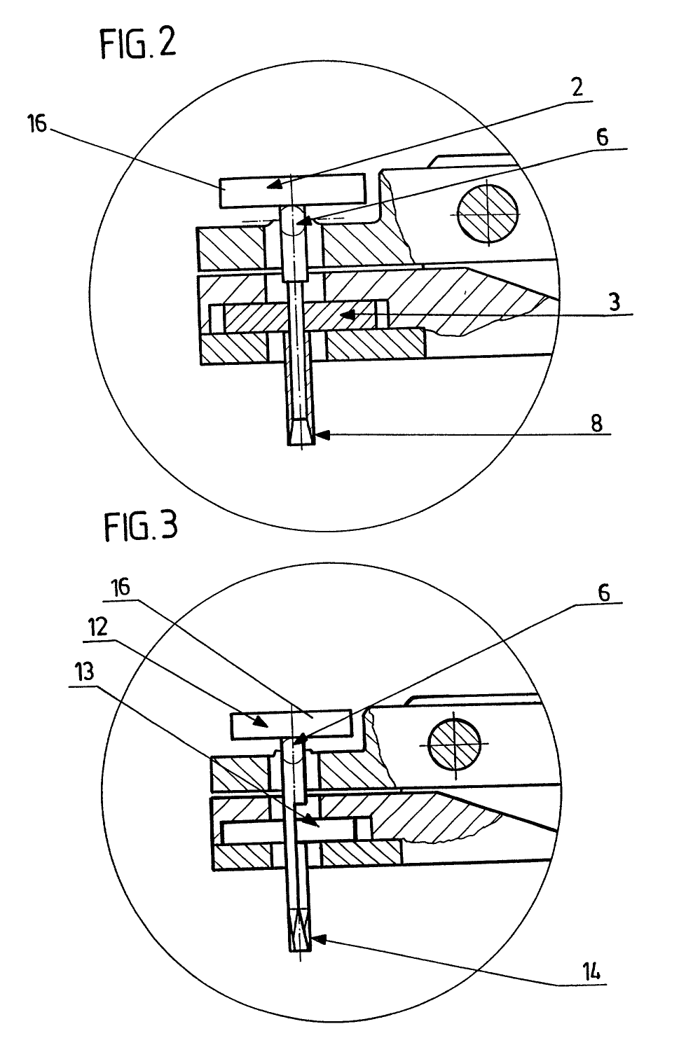

FIG. 2 shows the forceps head with the destruction bolt: drawing bolt 2 and slotted sleeve 3 which effect the actual splitting open of the tooth in a symmetric design.

FIG. 3 shows the forceps head with the destruction bolt: stationary half bolt 13 and drawing bolt 12 in a non-symmetric design.

Depending on the design, the destruction bolt 1 is pushed as far as possible into the prepared bore in the wisdom tooth. The forceps handles 4, 4a are then actuated. A lever 7 presses under the drawing bolt 2 and 12, respectively, via the forceps joint 5 and by means of the joint bearing 6. Since a stationary part is held by the front part of the forceps handle 4a, the drawing bolt 2 and 12, respectively, is displaced relative to it.

With the design according to FIG. 2: As the drawing bolt 2 has a conical extension 8 at its free end, it can press the slotted sleeve 3 apart. As a result, two symmetric forces are introduced into the tooth bore in longitudinal direction of the tooth and these forces break the tooth when they are of a suitable magnitude. The sleeve can also have a conical sliding surface.

With the design according to FIG. 3: Stationary holding bolt 13 and drawing bolt 12 are designed as half cylinders and both have a respective wedge surface 14 at the free end so that during the displacement of the drawing bolt 12 the wedge surfaces can slide on one another and the distance between the outer edges increases. In this case, as well, two symmetric forces are introduced into the tooth bore in longitudinal direction and these forces then break the tooth when the forces are of a suitable magnitude.

In order to prevent the tensioned manual force from pressing the tooth parts unnecessarily far apart at the moment the tooth breaks, a ratchet mechanism, which includes a ratchet nose 15, a forceps joint 5, a ratchet pawl 9, ratchet teeth 10, and a restoring spring 11, is integrated into the handle of the forceps. As a result, the stroke of the forceps handle 4 can be limited and the breaking forces are generated by a plurality of small manual strokes, whereby any springing back or uncontrolled splitting stroke is prevented.

If the forceps handle 4 is moved into release position C, the drawing bolt 2, 12 can be moved back into its initial position with the lever 7 and the forceps is removed from the tooth. This possibility is important, in particular, at the time when the breaking of the tooth has not succeeded, for whatever reasons, in order to then prevent the tool from jamming in the bore.

Since the making of the bore in the tooth by means of a cutting tool, drill or wheel stone need not lead to a precise diameter, it is also conceivable for the forceps to possibly have to be exchanged for forceps with a thicker drawing bolt measurement after the first attempt. In this case, as well, the return to the initial state is indispensable.

The destruction bolt 1 may be turned about its axis by means of a gripping surface 16 so that the direction of the breaking force generated is altered and thus breaking of the tooth in a specific direction can be brought about.

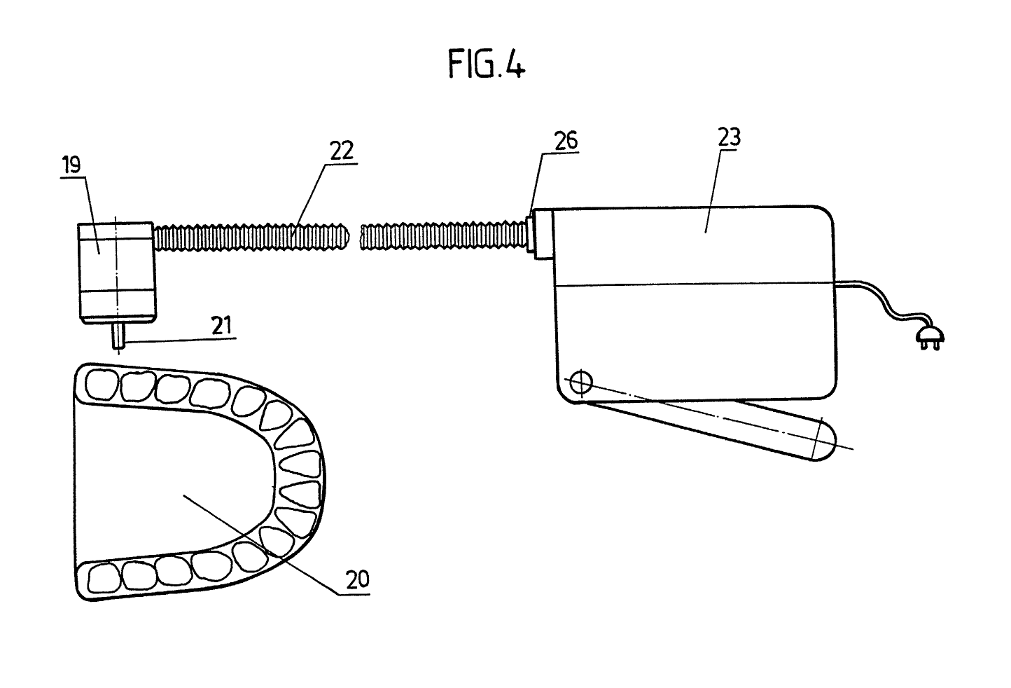

FIG. 4 shows a complete, hydraulically assisted breaking unit in its operating position. The breaking head 19, together with a hose 22, is coupled to a surgical supply system 23, which is already present, via a hydraulic plug-in system 26.

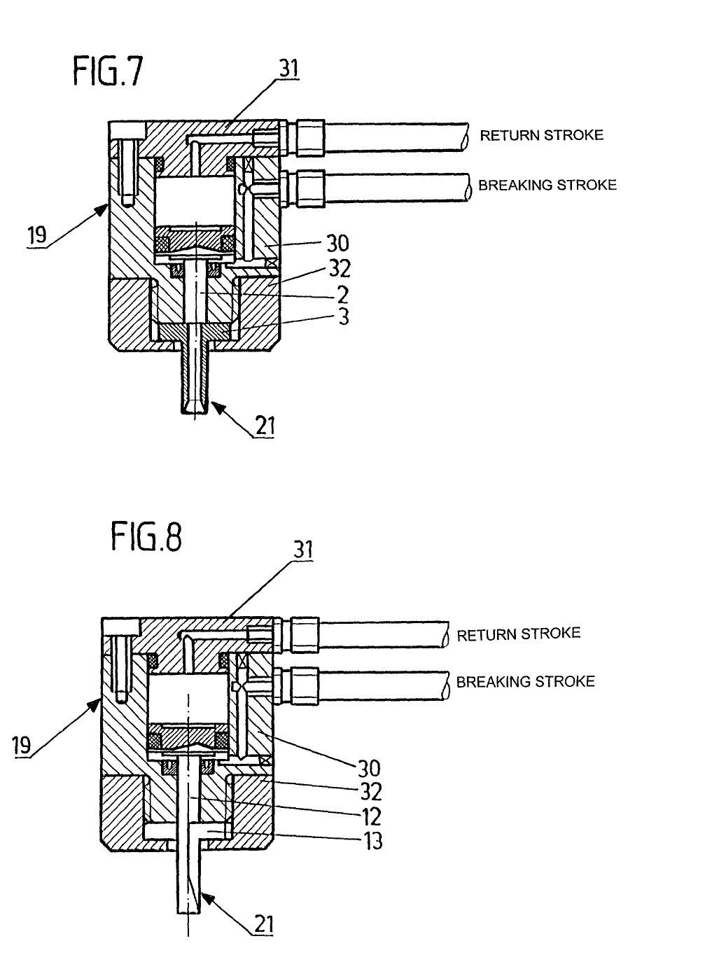

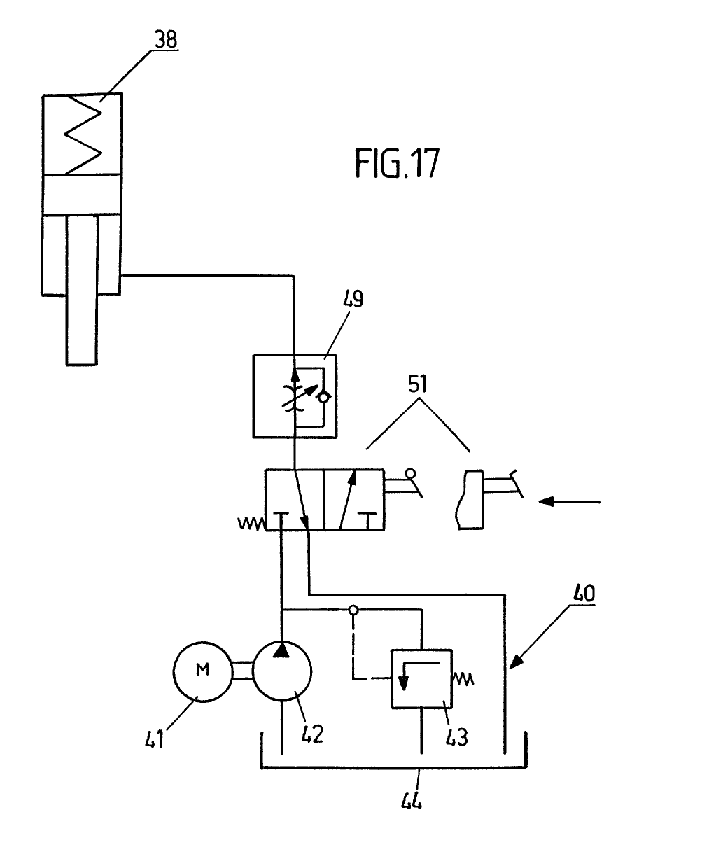

The drilled wisdom tooth is located in the lower jaw 20 and the lower, cylindrical attachment 21 of the breaking head 19 (FIGS. 7 to 14) is introduced into the tooth. A hose 22, in which the supply lines are located, makes a large treatment area possible and connects the breaking head to the supply and actuating unit 23 (FIGS. 15, 17) which makes a well regulated and delicate breaking of the tooth possible.

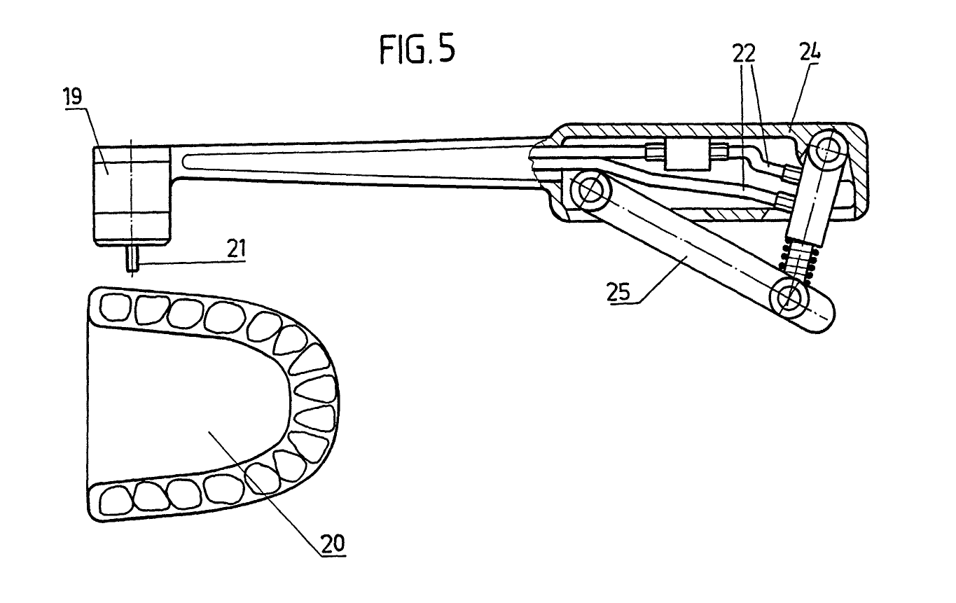

FIG. 5 shows a forceps-like tool in its operating position.

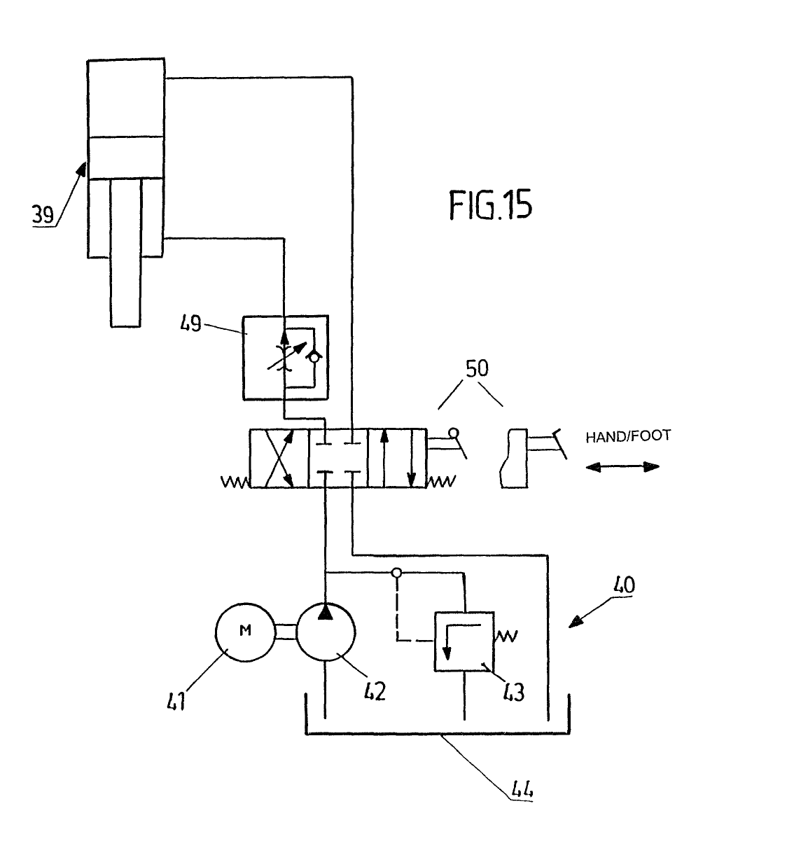

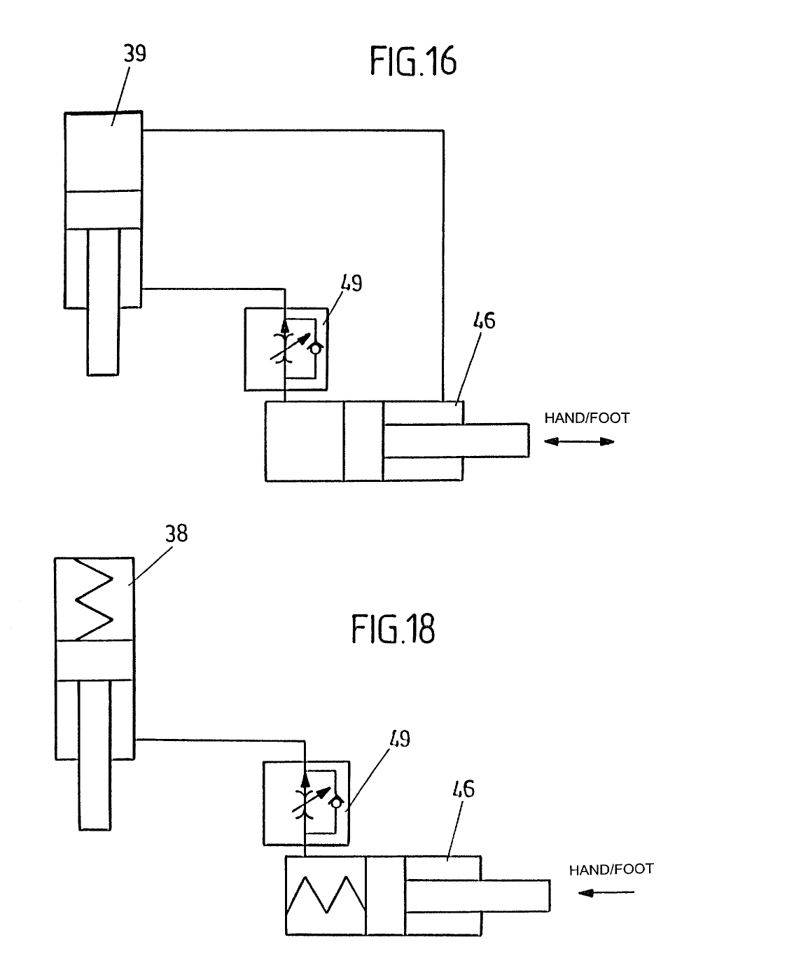

The drilled wisdom tooth is located in the lower jaw 20 and the lower, cylindrical attachment 21 of the breaking head 19 (FIGS. 7 to 14) is introduced into the wisdom tooth. The supply lines run through the housing 24 from the breaking head to the rear section, in which the cylinder 46 (FIG. 16) is located which generates the hydraulic supply pressure for the breaking and return strokes via the hand lever 25.

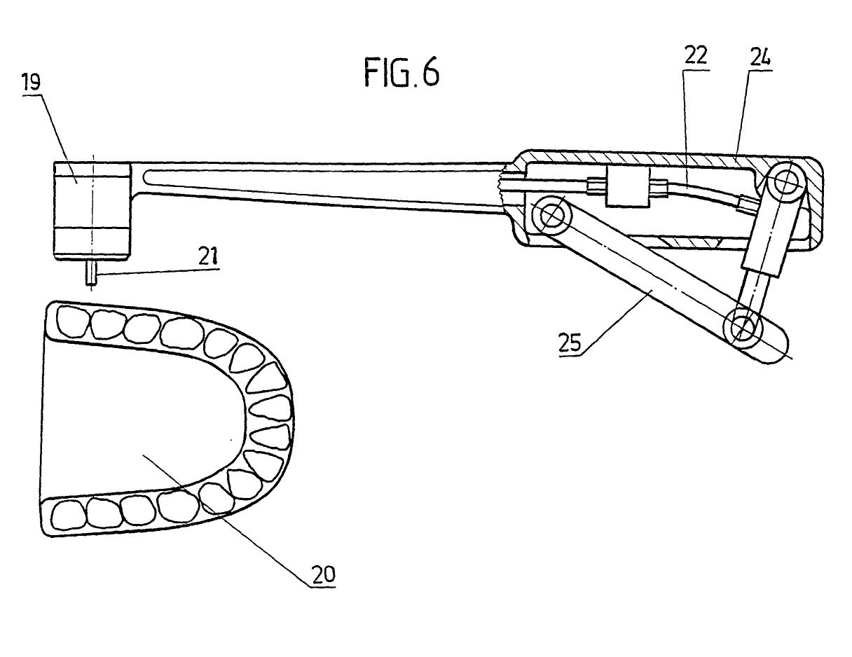

FIG. 6 shows an almost identical tool to FIG. 5 but, in this case, the breaking heads 19 (FIGS. 11 to 14) have been provided with a supply concept for a controlled breaking stroke and a spring-assisted return stroke which brings about differences in the area of the supply lines and the cylinder 46 (FIG. 18) in the area of the hand lever 25.

The Breaking Heads

FIGS. 7 and 8 show the hydraulically (water) assisted breaking head in a symmetric (FIG. 7) and non-symmetric (FIG. 8) design with controllable breaking and return strokes.

In the symmetric design, the drawing bolt 2 is pressed hydraulically upwards; the slotted sleeve 3 is thereby spread apart and symmetric forces introduced into the jaw which split the tooth open. The supply of the hydraulic medium (water) takes place via a lower connection (breaking stroke); subsequently, it is conducted via a control bushing 30 to the lower piston side of the drawing bolt 2, whereby the breaking stroke is carried out. The upper piston side of the drawing bolt 2 is supplied via an upper connection (return stroke).

A cover 31 is provided with a return flow bore and a cover 32 offers the contact edge for the slotted sleeve.

In the non-symmetric design, the drawing bolt 12 is pressed hydraulically upwards and the half bolt 13 performs a lateral stroke on account of the wedge surface, whereby symmetric forces are introduced into the tooth in this case, as well. The supply of the hydraulic medium (water) takes place in the same way as with the symmetric design, i.e. the following individual parts are identical:

the control bushing 30

the cover 31 as well as

the cover 32.

All the seals of the designs according to FIG. 7 and FIG. 8 are based on the use of the hydraulic medium water, wherein an exiting of small amounts of water into the mouth area is admissible.

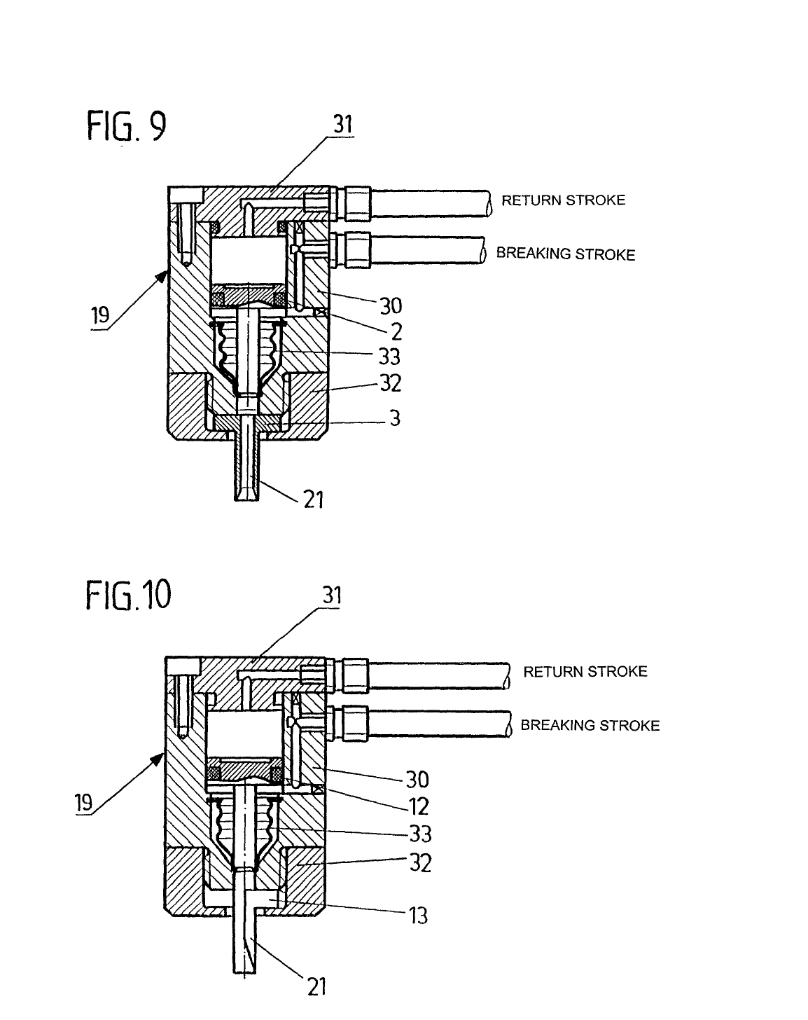

FIGS. 9 and 10 show the hydraulically (synthetic liquid) assisted breaking head in a symmetric (FIG. 9) and non-symmetric (FIG. 10) design with controllable breaking and return strokes.

The design of FIG. 9 has the same operating principle as that of FIG. 7, the decisive difference lies in the seals used which, in this design, represent an absolutely leak-free unit on account of an expansion bellows 33.

The non-symmetric design (FIG. 10) is comparable to that of FIG. 8; in this case, as well, the medium used (synthetic liquid) shows its effects. An expansion bellows 33 creates the high sealing effect.

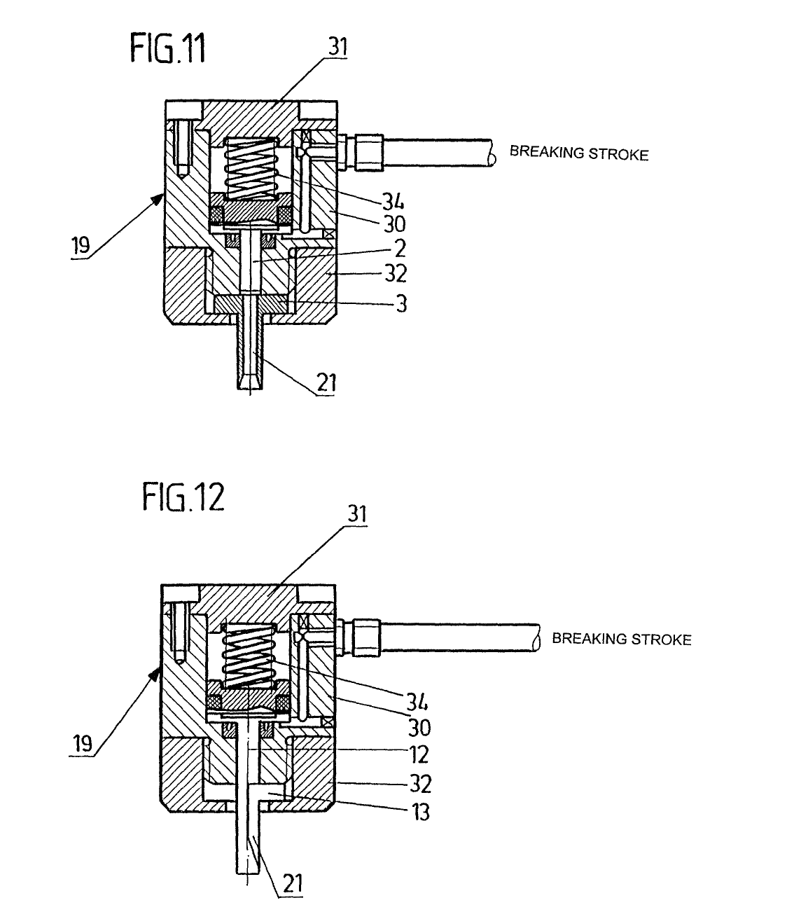

FIGS. 11 and 12 show the hydraulically (water) assisted breaking head in a symmetric (FIG. 11) and non-symmetric (FIG. 12) design with a controllable breaking stroke and spring-assisted return stroke.

The design of FIG. 11 is comparable to that of FIG. 7; in this respect, the return stroke of the drawing bolt 2 has, however, been realized via a pressure spring 34. As a result, the hydraulic drive and the required return flow bores in the cover 31 are omitted. The same changes, pressure spring 34 and cover 31, have been made in the version of FIG. 12 which otherwise is absolutely identical to the version of FIG. 8 on account of the unchanging medium (water).

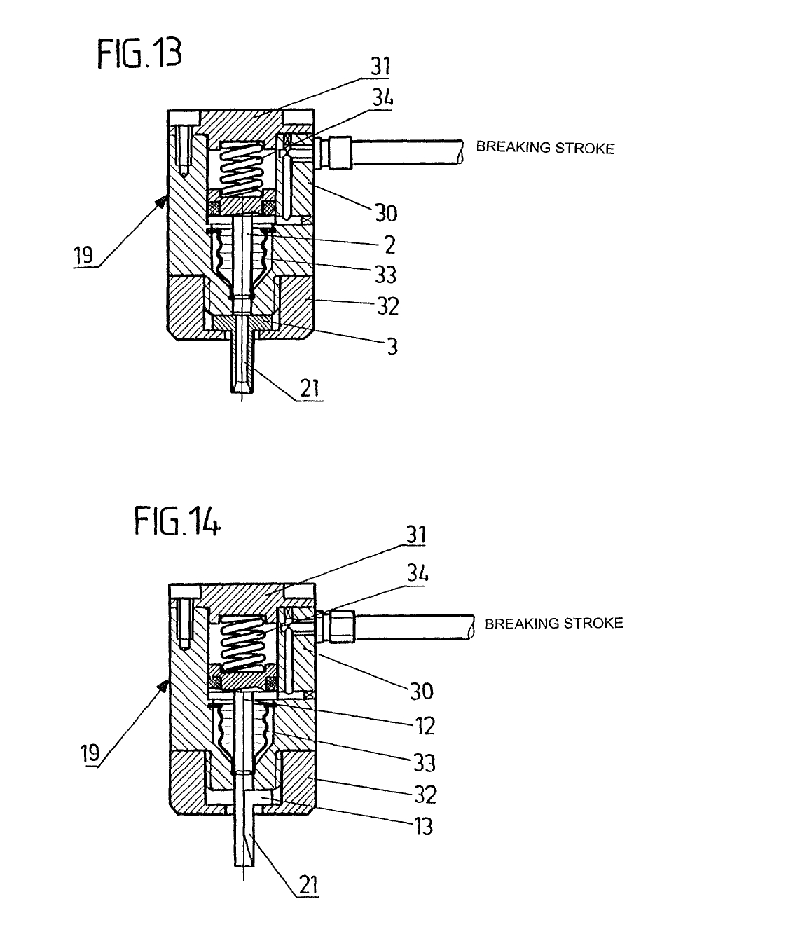

FIGS. 13 and 14 show the hydraulically (synthetic liquid) assisted breaking head in a symmetric (FIG. 13) and non-symmetric (FIG. 14) design with a controllable breaking stroke and spring-assisted return stroke.

The constructional criteria of the absolutely leak-free unit have been combined in the designs of FIGS. 13 and 14 with a spring-assisted return stroke so that the expansion bellows 33 and the pressure spring 34 have been included in the symmetric design and in the non-symmetric design the expansion bellows 33 and the pressure spring 34.

The Supply and Actuating Unit

FIG. 15 shows a hydraulically schematic overall concept for the remote-controlled breaking heads of FIGS. 7 to 10 with controllable breaking and return strokes.

The supply and the generation of the hydraulic pressure for the drive of the breaking heads of FIGS. 7 to 10, which are illustrated in FIG. 15 as a double-acting cylinder 39, is undertaken by an electrical drive unit 40 which comprises:

electric motor 41

hydraulic pump 42

pressure limiting valve 43

container 44.

The actuation and control of the breaking and return strokes is brought about via a 4/3-way acting valve 50 which is designed for operation by hand or foot.

The fine adjustment of the breaking stroke is ensured via the throttle check valve 49.

The elements 40, 49 and 50 are located in the supply and actuating unit 23 of FIG. 4.

FIG. 16 shows a hydraulic concept for the remote-controlled breaking heads of FIGS. 7 to 10 with controllable breaking and return strokes.

The generation of the hydraulic pressure for the drive of the breaking heads of FIGS. 7 to 10, which are illustrated in FIG. 15 as a double-acting cylinder 39, is applied via a manually operated unit 46. The fine adjustment of the breaking stoke is regulated via the control unit 49.

The elements 46, 49 are located in the housing 24 and the actuation of the cylinder or hydraulic piston 46 takes place via the hand lever 25 (FIG. 5).

FIG. 17 shows a hydraulically schematic overall concept for the remote-controlled breaking heads of FIGS. 11 to 14 with a controllable breaking stroke and spring-assisted return stroke.

The concept of FIG. 17 differs due to the single-acting cylinder 38 with spring resetting, the symbolic illustration of the breaking heads of FIGS. 11 to 14 from that of FIG. 15. The actuating unit represents a 3/2-way acting valve 51; additional circuitry symbols have an identical designation and function to that of FIG. 15, the same way as the connection to FIG. 4, i.e. the switching elements 40, 49, 51 are accommodated in the unit 23, is given in this case.

FIG. 18 shows a hydraulic concept for the remote-controlled breaking heads of FIGS. 11 to 14 with a controllable breaking stroke and spring-assisted return stroke.

FIG. 18 represents the same basic principle as FIG. 16 in that the hydraulic pressure is applied via the actuating unit 46 and the fine regulation of the breaking stroke is undertaken by the control unit 49; the essential change is to be seen in the controlled breaking heads which have a spring-assisted return stroke.

The arrangement of the units 46, 49 is clearly shown in FIG. 5.

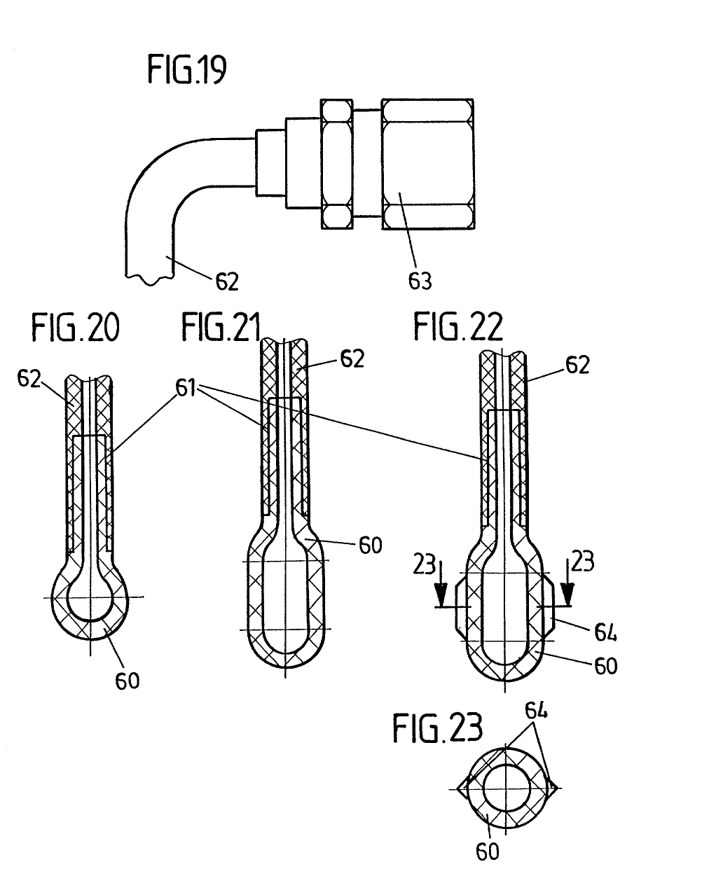

FIGS. 20 to 23 show three different forms of breaking elements, the main function of which, to introduce a rotationally symmetric pressure into the tooth, is provided by way of an expandable bellows 60.

The bellows 60 of FIG. 20 is a ball-shaped bellows which is introduced into the tooth bore. The bellows is connected via an adhesive connection 61 to a hose 62 and a screw connector 63 (FIG. 19), whereby a possibility is created of connecting a hydraulic supply and actuating unit 23 (FIGS. 17, 18).

If the bellows is acted upon with pressure, it expands for such a time until it abuts in the tooth bore on all sides and the pressure is transferred to the tooth; following a slow and delicate increase in pressure, the tooth subsequently breaks.

The bellows 60 of FIG. 21 is a cylinder-shaped bellows which differs from that of FIG. 20 only in the shape of the bellows.

The bellows 60 of FIG. 22 is a cylinder-shaped bellows with notched pieces 64 adhered to the sides which encourage breaking in a specific direction as a result of their acute-angled shape (FIG. 23).

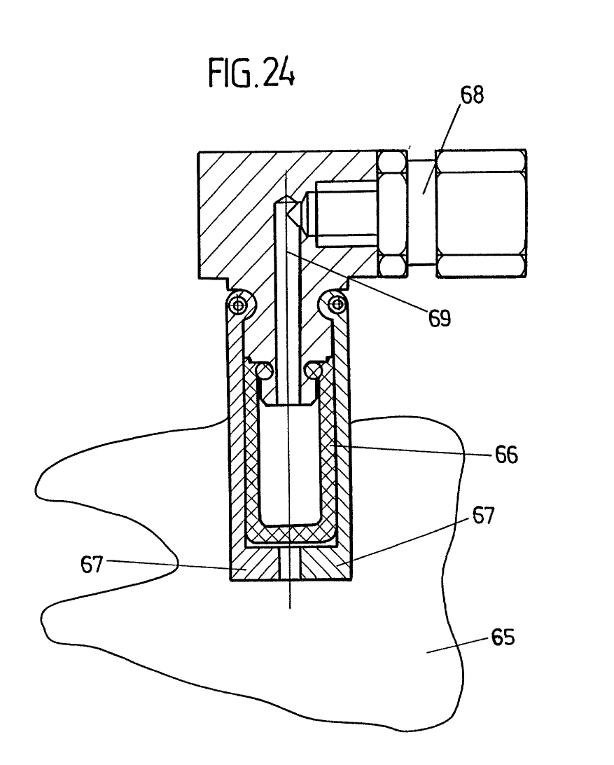

FIG. 24 shows a breaking element in a drilled tooth 65 which introduces a rotationally symmetric pressure into the tooth by means of bellows 66 and by means of segment pieces 67.

The required pressure is supplied via a screw connector 68, which can be combined with a supply and actuating system 23, to a control bushing 69 and thus to the bellows 66. If the bellows expands on account of the slowly increasing pressure, the segment pieces 67 which are pivotally mounted and spring-assisted are pressed apart. The individual segment pieces 67 press against the tooth bore and thus transfer the pressure which finally leads to the tooth breaking.

What is claimed is:

1. Device for the destruction of a tooth free from transverse forces and bending moments, comprising:
a destruction bolt introduceable into a bore of the tooth, wherein the outer dimensions of the destruction bolt are adapted to be increased in such a manner that the tooth is broken and thereby split open by means of internal pressure due to application of symmetric forces in the bore.

2. Device as defined in claim 1, wherein the destruction bolt comprises two parts movable relative to one another and having sliding surfaces sliding on one another during the movement of the two parts relative to one another and thereby increasing the outer dimensions of the destruction bolt.

3. Device as defined in claim 2, wherein one part forms a slotted sleeve and the other part forms a central drawing or pressure bolt displaceable therein and having a conical extension forming a sliding surface.

4. Device as defined in claim 2, wherein:
one part comprises a stationary half bolt;
the other part comprises a displaceable drawing or pressure bolt; and
both parts bear wedge surfaces sliding on one another as sliding surfaces.

5. Device as defined in claim 2, wherein the two parts are designed like blind rivets.

6. Device as defined in claim 2, further comprising:
a pair of breaking forceps having two forceps handles pivotable relative to one another;
wherein the two parts are movable relative to one another by means of said forceps handles.

7. Device as defined in claim 6, wherein the breaking forceps includes a ratchet mechanism for transforming a complete stroke of the forceps handles into a small partial stroke of the two parts.

8. Device as defined in claim 7, wherein the ratchet mechanism comprises an elbow lever engaging in teeth with its free end.

9. Device as defined in claim 6, wherein the two forceps handles are pivotable into a release position where the two parts are displaced relative to one another in such a manner that their outer dimensions are reduced.

10. Device as defined in claim 2, wherein:
the two parts are adapted to be moved away from one another towards opposite sides during the increase in the outer dimensions; and
the destruction bolt is mounted on the device so as to be rotatable about its longitudinal axis.

11. Device as defined in claim 2, wherein the two parts are movable relative to one another by means of a hydraulic drive for altering the outer dimensions of the destruction bolt.

12. Device as defined in claim 11, wherein the hydraulic drive comprises a pump driven by a motor.

13. Device as defined in claim 11, wherein the hydraulic drive comprises a hydraulic piston operated by hand or foot for generating actuating pressure for the hydraulic drive.

14. Device as defined in claim 13, further comprising a housing bearing the destruction bolt and accommodating an actuating and supply unit, wherein the housing forms a forceps-like tool together with a hand lever mounted thereon.

15. Device as defined in claim 13, wherein the drive is connected via a hose to an actuating and supply unit.

15. Device as defined in claim 15, wherein the connection between the hose and the actuating and supply unit comprises a plug-in connection.

17. Device as defined in claim 11, wherein the hydraulic drive comprises a piston sealingly displaceable in a bushing, one of the two displaceable parts being held on said piston.

18. Device as defined in claim 17, wherein:
a supply line for a hydraulic medium is arranged in the bushing on one side of the piston; and
the piston is displaceable in the bushing contrary to the action of a spring during supply of hydraulic medium via this supply line.

19. Device as defined in claim 17, wherein a supply line for a hydraulic medium is arranged in the bushing on both respective sides of the piston.

20. Device as defined in claim 17, wherein the piston is sealed in relation to the bushing by means of an expansion bellows.

21. Device as defined in claim 11, wherein the hydraulic drive comprises a bellows arranged between two parts and adapted to be filled with hydraulic medium, said bellows moving the two parts away from one another during filling, thereby increasing their outer dimensions.

22. Device as defined in claim 21, wherein the two parts are mounted so as to be pivotable away from one another.

23. Device as defined in claim 21, wherein the two parts are spring-assisted.

24. Device as defined in claim 1, wherein the destruction bolt comprises a bellows adapted to be filled with a hydraulic medium.

25. Device as defined in claim 24, wherein the bellows is of a ball-shaped design.

26. Device as defined in claim 24, wherein the bellows is of a cylinder-like design.

27. Device as defined in claim 24, wherein the bellows bears notched pieces added laterally.

28. Device as defined in claim 21, wherein the bellows is expandable.

29. A method for the destruction of a tooth free from transverse forces and bending moments, comprising the steps of:
introducing a destruction bolt into a bore of the tooth, said destruction bolt having outer dimensions adapted to be increased; and
applying internal pressure to the tooth by increasing said outer dimensions of the destruction bolt in such a manner that the tooth is broken and thereby split open by means of symmetric forces in the bore of the tooth.

30. A method as defined in claim 29, wherein the destruction bolt comprises two parts movable relative to one another and having sliding surfaces sliding on one another during the movement of the two parts relative to one another and thereby increasing the outer dimensions of the destruction bolt.

31. A method as defined in claim 30, wherein one part forms a slotted sleeve and the other part forms a central drawing or pressure bolt displaceable therein and having a conical extension forming a sliding surface.

32. A method as defined in claim 30, wherein:
one part comprises a stationary half bolt;
the other part comprises a displaceable drawing or pressure bolt; and
both parts bear wedge surfaces sliding on one another as sliding surfaces.

33. A method as defined in claim 30, wherein the two parts are designed like blind rivets.

34. A method as defined in claim 30, further comprising moving the two parts relative to one another using breaking forceps having two forceps handles, which forceps handles are pivotable relative to one another.

35. A method as defined in claim 34, wherein the breaking forceps include a ratchet mechanism for transforming a complete stroke of the forceps handles into a small partial stroke of the two parts.

36. A method as defined in claim 35, wherein the ratchet mechanism comprises an elbow lever engaging in teeth with its free end.

37. A method as defined in claim 34, further comprising pivoting the two forceps handles into a release position where the two parts are displaced relative to one another in such a manner that their outer dimensions are reduced.

38. A method as defined in claim 29, further comprising:
moving the two parts away from one another towards opposite sides during the increase in the outer dimensions; and
mounting the destruction bolt on the device so as to be rotatable about its longitudinal axis.

39. A method as defined in claim 30, further comprising moving the two parts relative to one another by means of a hydraulic drive for altering the outer dimensions of the destruction bolt.

40. A method as defined in claim 39, wherein the hydraulic drive comprises a pump driven, and driving said pump with a motor.

41. A method as defined in claim 39, wherein the hydraulic drive comprises a hydraulic piston, and operating said piston by hand or foot for generating actuating pressure for the hydraulic drive.

42. A method as defined in claim 41, further comprising:
providing a housing for bearing the destruction bolt and accommodating an actuating and supply unit;
said housing forming a forceps-like tool together with a hand lever mounted thereon.

43. A method as defined in claim 41, further comprising connecting the drive to an actuating and supply unit via a hose.

44. A method as defined in claim 43, wherein the connection between the hose and the actuating and supply unit comprises a plug-in connection.

45. A method as defined in claim 39, wherein the hydraulic drive comprises a piston sealingly displaceable in a bushing, one of the two displaceable parts being held on said piston.

46. A method as defined in claim 45, further comprising:
arranging a supply line for a hydraulic medium in the bushing on one side of the piston; and
supplying a hydraulic medium via the supply line to displace the piston in the bushing contrary to the action of a spring.

47. A method as defined in claim 45, further comprising arranging a supply line for a hydraulic medium in the bushing on both respective sides of the piston.

48. A method as defined in claim 45, further comprising sealing the piston in relation to the bushing by means of an expansion bellows.

49. A method as defined in claim 30, further comprising:
arranging a bellows between said two parts; and
filling said bellows with a hydraulic medium;
wherein said bellows move the two parts away from one another during filling, thereby increasing said outer dimensions.

50. A method as defined in claim 49, further comprising mounting the two parts so as to be pivotable away from one another.

51. A method as defined in claim 49, wherein the two parts are spring-assisted.

52. A method as defined in claim 29, wherein the destruction bolt comprises a bellows adapted to be filled with a hydraulic medium.

53. A method as defined in claim 52, wherein the bellows is of a ball-shaped design.

54. A method as defined in claim 52, wherein the bellows is of a cylinder-like design.

55. A method as defined in claim 52, wherein the bellows bears notched pieces added laterally.

56. A method as defined in claim 49, wherein the bellows is expandable.
